(19) United States
(12) Patent Application Publication
(10) Pub. No.: US 2013/0133324 A1
(43) Pub. Date: May 30, 2013

(54) HYBRID SOLAR POWER PLANT

(71) Applicant: GOSSAMER SPACE FRAMES, Huntington Beach, CA (US)

(72) Inventor: Glenn A. Reynolds, Laguna Hills, CA (US)

(73) Assignee: GOSSAMER SPACE FRAMES, Huntington Beach, CA (US)

(21) Appl. No.: 13/690,762

(22) Filed: Nov. 30, 2012

Related U.S. Application Data
(60) Provisional application No. 61/565,014, filed on Nov. 30, 2011.

(51) Int. Cl. F03G 6/06; F01K 13/00; F01K 25/08; F01K 11/02

(52) U.S. Cl. CPC F03G 6/065; F01K 11/02; F01K 13/00; F01K 25/08
USPC 60/641.15; 60/676; 60/679; 60/651; 60/653

(57) ABSTRACT

A solar power plant includes a first solar reflective system configured to heat a first heat transfer fluid to a temperature within a first temperature range and at least a second solar reflective system coupled to the first solar reflective system, the second solar reflective system having a second heat transfer fluid configured to be heated to a temperature within the first temperature range by the first heat transfer fluid, the second solar reflective system configured to heat the second heat transfer fluid to a temperature within a second temperature range. The solar power plant may also include a power generation system coupled to the first solar reflective system and the second solar reflective system and configured to generate electricity by receiving heat from the first heat transfer fluid and the second heat transfer fluid.

### RELATED APPLICATIONS

The present application claims the benefit of U.S. Provisional Application Ser. No. 61/565,014, filed on Nov. 30, 2011, the entire disclosure of which is incorporated herein by reference.

### FIELD

This disclosure generally relates to concentrated solar power generation systems, and more particularly, to a hybrid solar power plant.

### BACKGROUND

Reflective solar power generation systems generally reflect and/or focus sunlight onto one or more receivers carrying a heat transfer fluid (HTF). The heated HTF is then used to generate steam for producing electricity. One type of reflective solar power generation system may use a number of spaced apart reflective panel assemblies that surround a central tower and reflect sunlight toward the central tower (hereinafter referred to as a central receiver system). Another type of reflective solar power generation system may use parabolic-shaped reflective panels that focus sunlight onto a tube receiver at the focal point of the parabola defining the reflective panels (hereinafter referred to a trough system). An HTF is heated in a trough system to about 300-400° C. (570-750° F.). The hot HTF is then used to generate steam by which the steam turbine is operated to produce electricity with a generator. In the central receiver system, an HTF is heated to about 500-800° C. (930-1480° F.).

### BRIEF DESCRIPTION OF THE DRAWINGS

FIG. 1 shows a method of generating power from a solar power plant according to one example.

FIG. 2 shows a block diagram of a hybrid solar power plant according to one embodiment.

FIG. 3 shows a schematic diagram of a central receiver system according to one embodiment.

FIG. 4 shows a schematic diagram of a trough system according to one embodiment.

FIG. 5 shows a schematic diagram of a power block according to one embodiment.

FIG. 6 shows a schematic diagram of a power block according to another embodiment.

FIG. 7 shows a schematic diagram of a central receiver system according to another embodiment.

FIG. 8 shows a schematic diagram of a trough system according to another embodiment shown with the central receiver system of FIG. 7.

FIG. 9 is a schematic view of a receiver of a central receiver system.

FIG. 10 is a schematic view of a receiver of a central receiver system according to one embodiment.

FIG. 11 is a detailed schematic view of the receiver of FIG. 10.

FIG. 12 is a schematic view of a receiver assembly of the central receiver system according to one embodiment.

FIGS. 13-16 show examples of receiver tubes according to the disclosure.

FIG. 17 shows a cross-sectional view of the receiver tube according to one embodiment.

### DETAILED DESCRIPTION

According to the disclosure, a hybrid solar power plant may include a plurality of solar power generation systems which may be operatively coupled to produce electricity from solar energy. Each of the plurality of solar power generation systems may heat a corresponding heat transfer fluid (HTF) to a certain temperature range within an overall operating temperature range of the hybrid solar power plant. The operating temperature range of each of the solar power generation systems may be different than or have some overlap with the operating temperature ranges of the other solar power generation systems. Accordingly, as described in detail by the examples below, the hybrid solar power plant may generate steam by each power generation system heating a corresponding HTF to within a certain temperature range of the overall temperature range of the hybrid solar power generation system and contributing to increasing the operating temperature of the hybrid solar power plant to the maximum operating temperature.

The hybrid solar power plant may include one or more central receiver systems, one or more trough systems, one or more a dish-type reflective systems and/or other types of reflective systems by which solar radiation is focused on to a region to heat an HTF, which is then used to generate steam to operate a steam turbine to generate electricity with a steam generator. A hybrid solar power generation system having a central receiver system and a trough system is described in detail below. However, any number and/or types of solar power generation systems may be used to provide a hybrid solar power generation systems according to the disclosure.

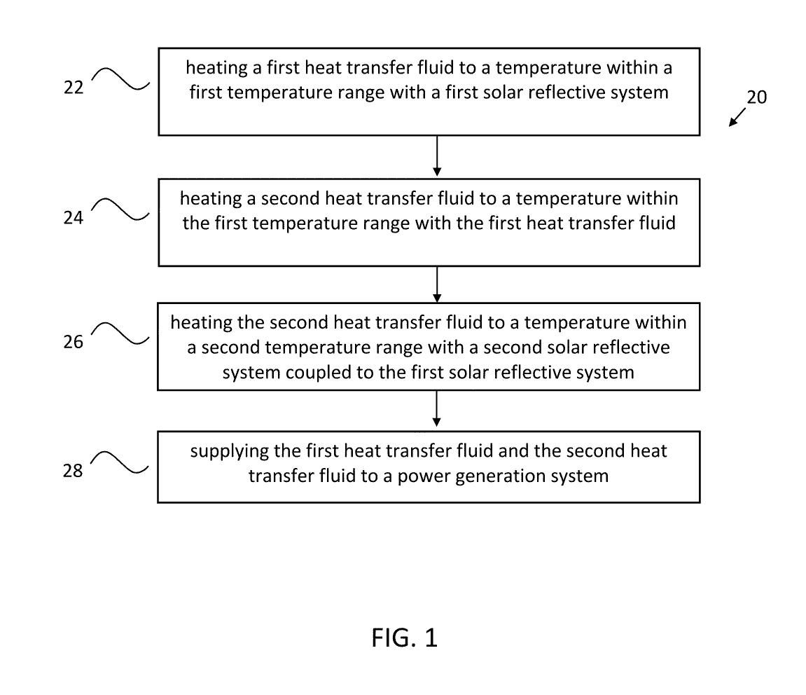

Referring to FIG. 1, a method 20 of generating heat, power and/or electricity from solar energy includes heating a first heat transfer fluid to a temperature within a first temperature range with a first solar reflective system (block 22), and heating a second heat transfer fluid to a temperature within the first temperature range with the first heat transfer fluid (block 24). The method 20 further includes heating the second heat transfer fluid to a temperature within a second temperature range with a second solar reflective system coupled to the first solar reflective system (block 26), and supplying the first heat transfer fluid and the second heat transfer fluid to a power generation system (block 28).

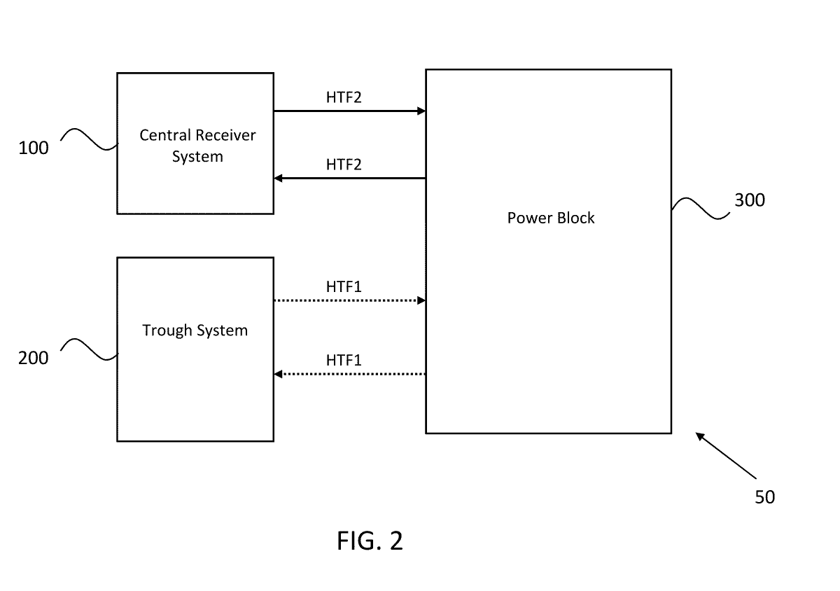

FIG. 2 shows a block diagram of a hybrid solar power plant 50 (hereinafter referred to as the hybrid plant 50) according to one embodiment. The hybrid plant 50 includes a central receiver system 100, which may be also referred to as a first solar reflective system, a solar trough system 200 (hereinafter referred to the trough system 200), which may be also referred to as a second solar reflective system, and a power block 300, which may be referred to as a power generation system, all of which are operatively coupled to produce electricity from solar energy. The trough system 200 uses the energy of the sun to heat a first heat transfer fluid (HTF1) to about 300-400° C. (570-750° F.), i.e., a first temperature range. The central receiver system 100 uses the energy of the sun to heat a second heat transfer fluid (HTF2) to about 500-800° C. (930-1480° F.), i.e., a second temperature range. As shown in FIG. 2, both the hot HTF1 and the hot HTF2 are transferred to the power block 300. As described in detail below, the heat in the HTF1 and the HTF2 are used in the power block to generate electricity. The cooled HTF1 and HTF2, which are also referred to herein as the cold HTF1 and the cold HTF2 are returned to the trough system 200 and the central receiver system 100, respectively, to repeal the above-described cycle.

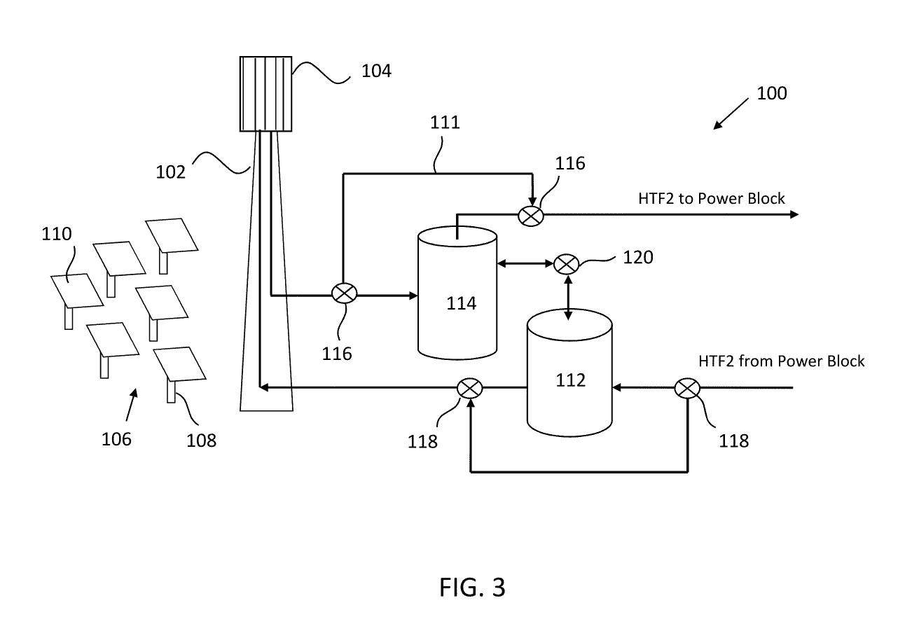

FIG. 3 is a schematic diagram of an exemplary central receiver system 100 according to one embodiment. The central receiver system 100 includes a tower 102 and a receiver 104 positioned at or near the top of the tower 102. The tower 102 is typically positioned at the center of a plurality of reflector assemblies 106, which are arranged in a rectangular, a circular, or other configuration around the tower 102. Each reflector assembly 106 includes a mounting pole or a pylon 108 that is fixed to the ground and a reflective surface 110, which directs and generally focuses sunlight onto the receiver 104. Each reflector assembly 106 also includes a heliostat (not shown) which controls the position of the reflective surface 110 so as to track the position of the sun. Thus, all of the reflective surfaces 110 track the position of the sun and direct and generally focus sunlight onto the receiver 104.

The central receiver system 100 includes an HTF2 loop 111, by which the HTF2 is carried through various components of the central receiver system 100 as described herein. The cold HTF2 is transferred from a cold tank 112 to a plurality of tubes (not shown) inside the receiver 104. The cold HTF2 is then heated in the receiver 104 as a result of receiving focused sunlight from the reflector assemblies 106. The hot HTF2 is then transferred from the receiver 104 to a hot tank 114. The HFT2 may be a salt or salt compound, which is in liquid form in both the cold and hot states. In the cold state, the HFT2 has a temperature that is above the freezing point of HTF2. Preferably, however, the HTF2 may have a temperature that is greater than the freezing point of HTF2 by a large margin to prevent freezing of the HTF2 in the central receiver system 100.

The hot tank 114 and the cold tank 112 function as energy storage devices. The hot HTF2 from the hot tank 114 is supplied to the power block 300, where the heat in the hot HTF2 is used to generate electricity as described in detail below. After the heat from the hot HTF2 is extracted to generate electricity, the cold HTF2 from the power block 300 returns to the cold tank 112 to repeat the above-described cycle. However, the hot HTF2 may be supplied directly to the power block 300 from the receiver 104 by bypassing, the hot tank 114 with valves 116. Similarly, the cold HTF2 returning from the power block 300 may be directly transferred to the receiver 104 by bypassing the cold tank 112 with valves 118. The hot tank 114 and the cold tank 112 can transfer HTF2 to each other in order to regulate and control the temperature of the HTF2 in the HTF2 loop 111. The transfer of HTF2 to and from the cold tank 112 and the hot tank 114 is controlled by the valve 120.

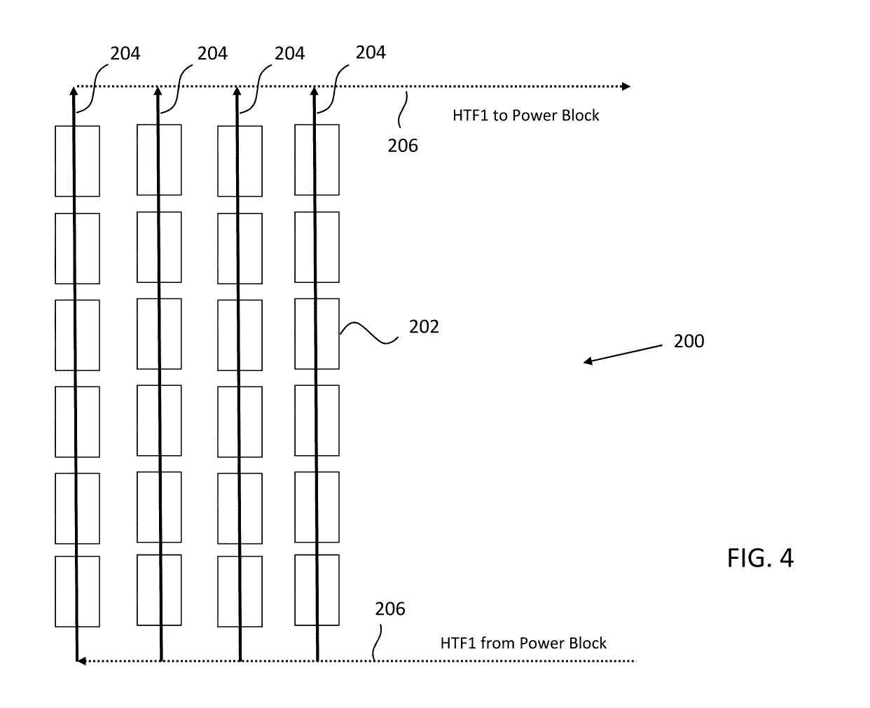

FIG. 4 is a schematic diagram of trough system 200 according to one embodiment. The trough system 200 includes a plurality of parabolic reflective surfaces 202 that may be arranged in rows. Each row of reflective surfaces 202 includes a receiver tube 204 that is positioned along the focal lines of the reflective surfaces 202. A control system (not shown) rotates the reflective surfaces 202 during the day to track the position of the sun. Accordingly, the reflective surfaces 202 focus sunlight onto the corresponding receiver tubes 204 throughout the day. The trough system 200 includes an HTF loop 206, by which the HTF1 is carried through various components of the trough system 200 as described herein. The HTF1 may be synthetic oil. The cold HTF1 is supplied to the receiver tubes 204 from the HTF1 loop 206. The resulting hot HTF1 is returned to the HTF1 loop 206. The hot HTF1 is supplied to the power block 300, in which the heat from the hot HTF1 is used to generate electricity as described in detail below. After using the hot HTF1 to generate electricity, the power block 300 returns the cold HTF1 to the receiver tubes 204 to repeat the above-described cycle.

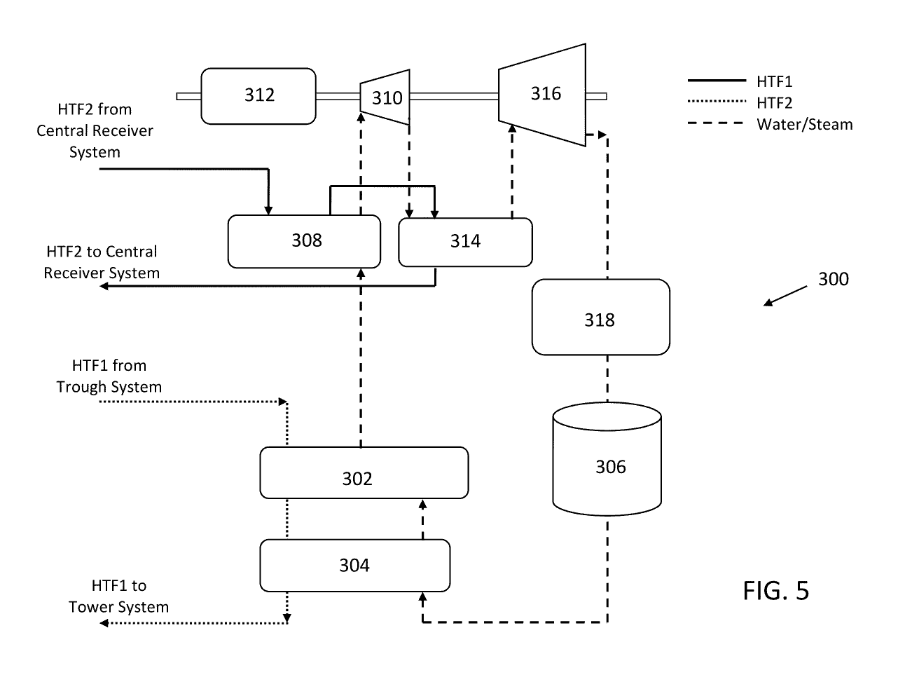

FIG. 5 is a schematic diagram of a power block 300 according to one embodiment. The power block 300 includes a steam generator 302 that receives the hot HTF1 from the HTF1 loop 206 and heated water from a preheater 304. The stream generator 302 may also receive water that is not preheated. The steam generator 302 uses the thermal energy in the HTF1 to convert the water or the heated water to steam, which may be referred to herein as the first steam. The HTF1 downstream of the steam generator 302 is used in the preheater 304 to heat the water that is supplied from a condensate tank 306 to the preheater 304.

The first steam from the steam generator 302 is supplied to a superheater 308. The hot HTF2 is supplied from the central receiver system 100 to the superheater 308, which uses the thermal energy of the HTF2 to further heat the first steam to provide a higher energy steam, which may be referred to herein as a second steam. The second steam is then supplied to a steam turbine 310, which operates a generator 312 to produce electricity. The steam turbine 310 may be a high pressure steam turbine. The first steam may be saturated steam or wet steam, superheated steam, or a combination of wet steam and superheated steam. The second steam may be saturated steam or wet steam, superheated steam, or a combination of wet steam and superheated steam. However, the second steam has higher energy than the first steam.

The steam downstream of the steam turbine 310 is transferred to a reheater 314, which uses the thermal energy of the HTF2 downstream of the superheater 308 to reheat the steam. The reheated steam is then supplied to a steam turbine 316 to produce electricity. The steam turbine 316 may be a low pressure steam turbine. The steam turbine 310 and the steam turbine 316 may define stages or cycles of a single steam turbine. The cooled steam downstream of the steam turbine 316 is condensed to water in a condenser 318 and is then transferred to the condensate tank 306 to repeat the above-described power block cycle.

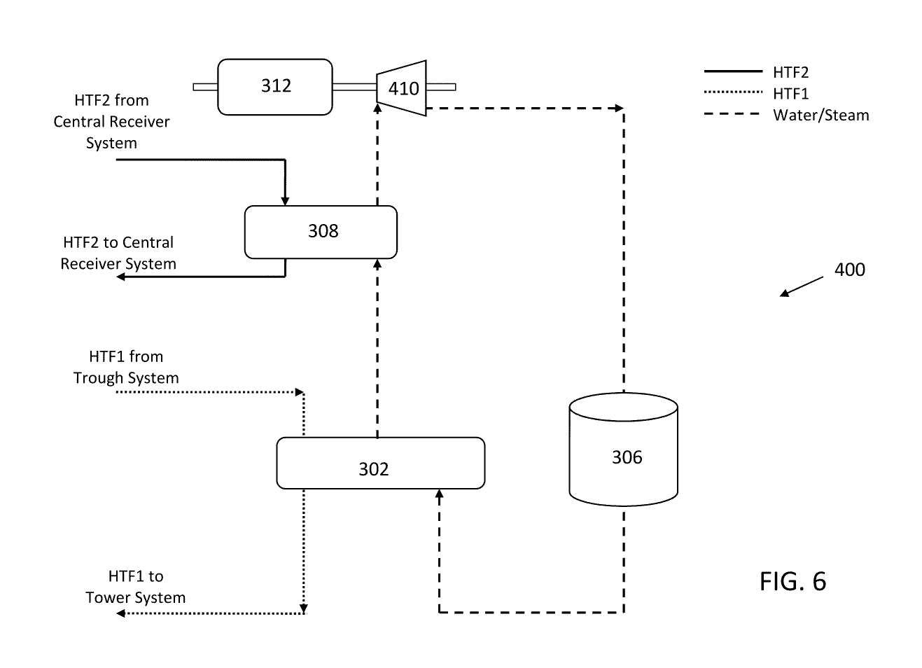

FIG. 6 is a schematic diagram of a power block 400 according to another embodiment. The power block 400 may have similar components as the power block 300. Therefore, similar components are referred to with the same reference numbers. Power block 400 represents a generally basic power block that may be used in the hybrid plant 50. The power block 400 includes a steam generator 302, a superheater 308, a steam turbine 410, a generator 312, and a condensate tank 306. The steam generator 302 receives the hot HTF1 from the HTF1 loop 206 and uses the thermal energy in the hot HTF1 to convert water supplied from the condensate tank 306 to the first steam. The first generated steam from the steam generator 302 is supplied to a superheater 308. Hot HTF2 is supplied from the central receiver system 100 to the superheater 308, which uses the thermal energy of the HTF2 to generate the second steam. The second steam is then supplied to the steam turbine 410, which operates a generator 312 to produce electricity. The cool steam downstream of the steam turbine 410 is then transferred to the condensate tank 306 to repeat the above-described power block cycle. Power blocks 300 and 400 represent two exemplary power blocks according to the disclosure. Any power block configuration may be constructed according to the disclosure that is similar to the power block 300 or 400 and/or includes any one or more of the components of the power blocks 300 and 400.

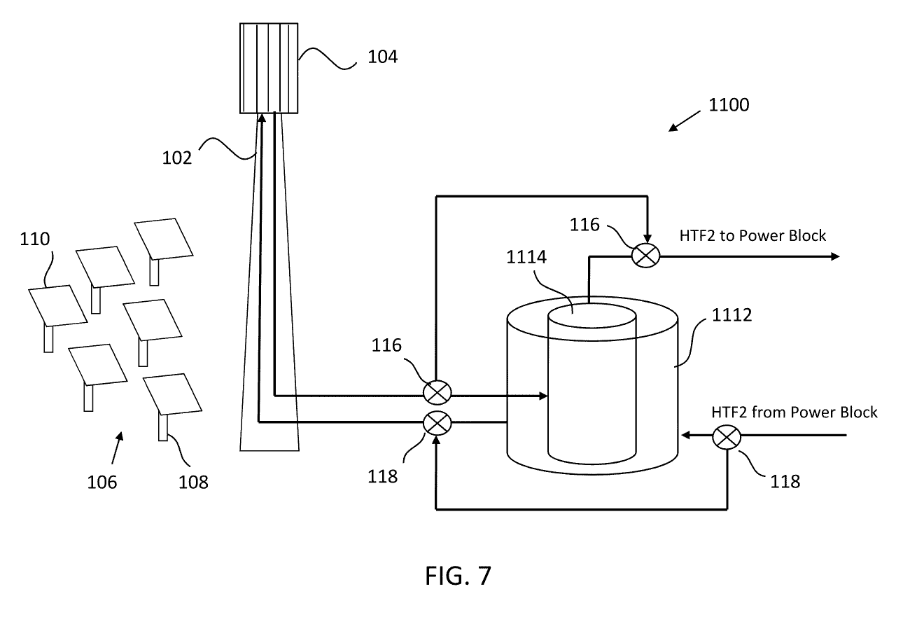

FIG. 7 shows a central receiver system 1100 according to another embodiment, which is referred to herein as the central receiver system 1100. The central receiver system 1100 is similar in some respects to the central receiver system 100. Therefore, the same parts are referred to with the same reference numbers and a description of these parts is not provided for brevity.

The central receiver system 1100 includes a cold tank 1112 for storing the cold HTF2 and a hot tank 1114 for storing the hot HTF2. The tanks 1112 and 1114 are arranged so that the cold HTF2 surrounds at least a portion of the hot tank 1114. In the example of FIG. 7, the cold tank 112 is a hollow cylinder in which the hot tank 1114 is nested. Accordingly, the cold tank 1112 substantially surrounds the hot tank 1114. The cold HTF2 of the cold tank 1112 may function as insulation for the hot HTF2 in the hot tank 1114. Additionally, any heat that is lost from the hot HTF2 can be mostly transferred to or captured by the cold HTF2 in the cold tank 1112. Accordingly, the overall heat loss in the HTF2 is reduced and the overall heat in the hot tank 1114 and the cold tank 1112 is conserved.

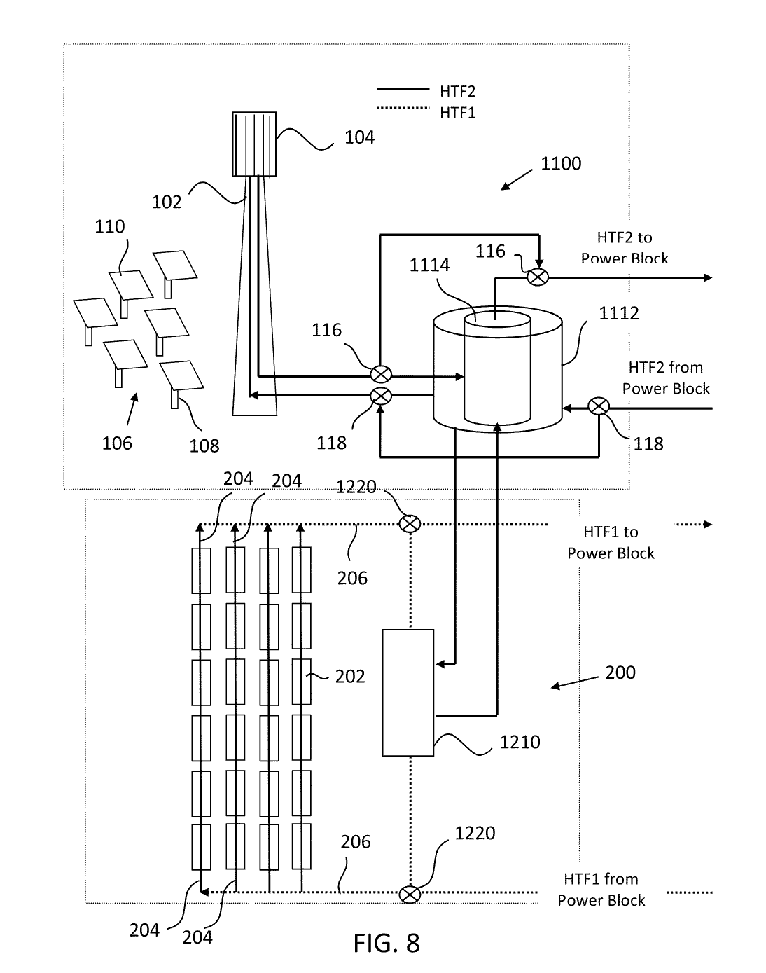

FIG. 8 shows a solar trough system 1200 according to another embodiment, which is referred to herein as the trough system 1200. The trough system 1200 is similar in some respects to the trough system 200. Therefore, the same parts are referred to with the same reference numbers and a description of these parts is not provided for brevity. FIG. 8 also shows the central tower system 1100 to illustrate the operation of the solar trough system 1200 and the central tower system 1100 and the hybrid plant 50. However, the central tower system 100 of FIG. 3 can also operate with the solar trough system 1200 in the hybrid plant 50.

The trough system 1200 includes an HTF2 heater 1210. The HTF2 heater 1210 receives cold HTF2 from the cold tank 1112 or 112 (not shown), heats the HTF2 and transfers the heated HTF2 to the hot tank 1114 or 114 (not shown) and/or back to the cold tank 1112 or 112. The heater 1210 receives hot HTF1 from the HTF1 loop 206. The hot HTF1 is used in the heater 1210 to heat the HTF2. The heater 1210 may provide heating of the HTF2 with the HTF1 when a hybrid plant according to the disclosure starts operations for the first time. Furthermore, the heater 1210 may maintain the temperature of the cold HTF2 above the freezing point of HTF2 if necessary. For example, during maintenance of the central receiver system 100 or 1100, i.e., when the central receiver system 100 or 1100 is not operational, the HTF2 can be heated with the heater 1210 to prevent the HTF2 from freezing. In the event that the HTF2 is frozen in all or parts of the central tower system 100 or 1100, heated air can be injected into various parts including pipes or tubes of the central tower system 100 or 1100 to melt the frozen HTF2. The air can be heated with the heater 1210. However, under certain circumstances, the hot tank 114 or 1114 may have a supply of hot HTF2, by which the air can be heated for melting the HTF2 in the pipes, tubes or other parts of the central tower system 100 or 1100. As shown in FIG. 8, the trough system 1200 may include two valves 1220, by which the operation of the heater 120 and/or the amount of HTF used for the heater 1210 may be controlled.

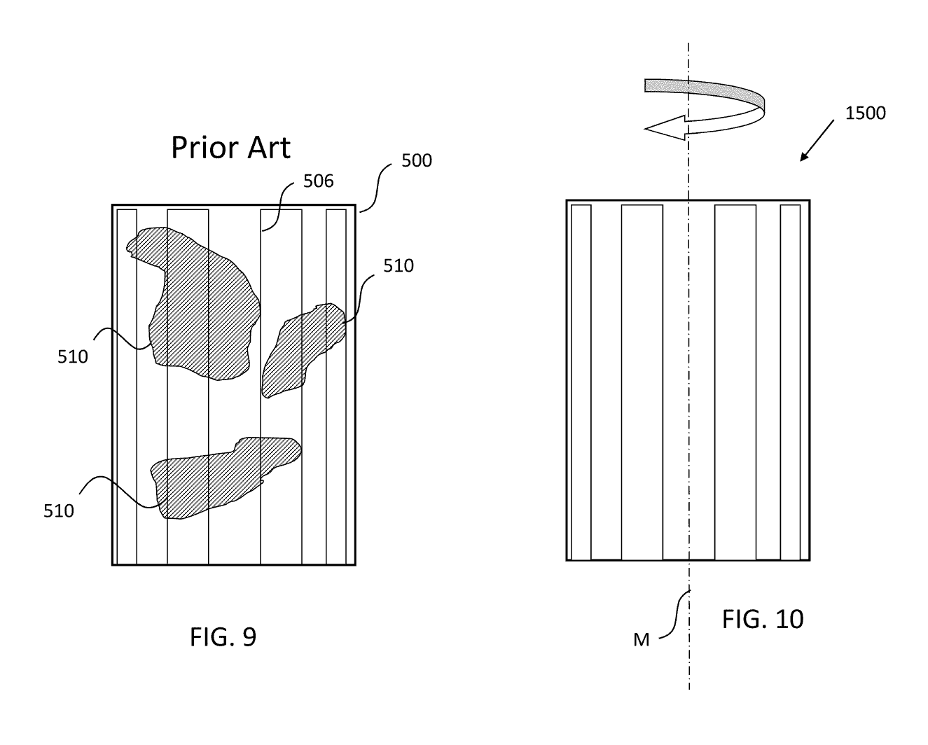

Referring to FIG. 9, a typical receiver 500 of a central receiver system is shown. The receiver 500 is generally cylindrical and includes tubes 506 onto which sunlight is focused from a large field of reflector panels. The tubes 506 transfer the heat from the focused sunlight to the HTF2 that flows through the tubes 506. The focusing areas of the reflectors on the receiver 500 may not be uniformly distributed onto the receiver 500 according to the position of the reflectors in the reflector field because of: irregularities in the reflector field; a number of inoperative reflectors at various locations in the field; inability of several reflectors to accurately focus sunlight onto the receiver; and/or other possible reasons, the receiver may experience regions of heat flux. Accordingly, certain areas of the receiver 500 may experience very high heat, while other areas may experience lower heat. For example, FIG. 9 shows regions 510 as receiving a disproportionate amount of focused sunlight from the reflector field as compared to the remaining regions of the receiver 500.

FIG. 10 shows a receiver 1500 according to one embodiment. The receiver 1500 rotates about the receiver's central axis M to uniformly distribute the regions of heat flux, i.e., regions 510 shown in FIG. 8. Thus, the same locations on the receiver may not experience the regions 510 of FIG. 8 due to the rotation of the receiver. Therefore, the HTF2 flowing through the receiver 1500 is uniformly heated. Furthermore, damage to the receiver 1500 as a result of extreme heat at the regions 510 is prevented.

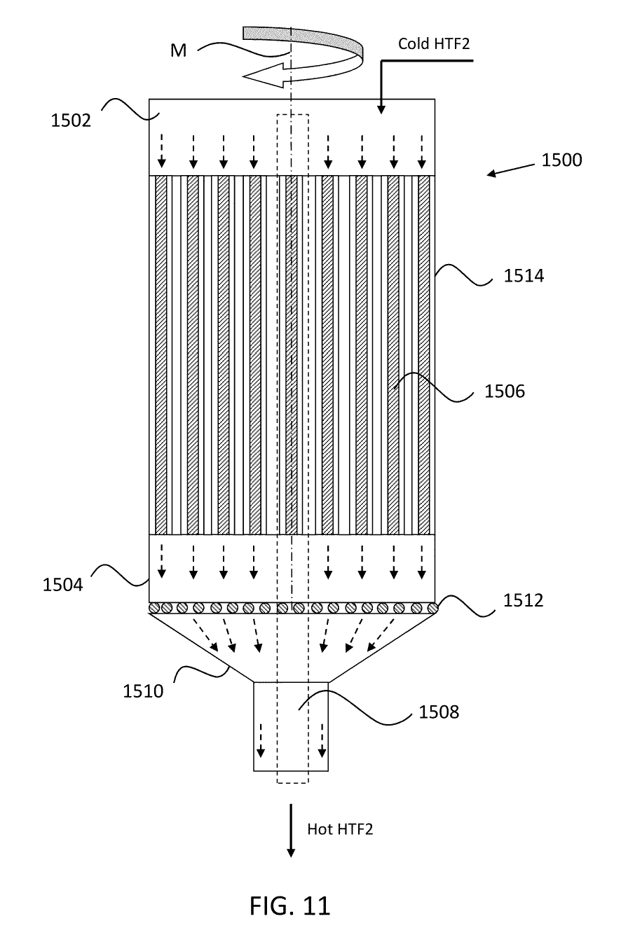

FIG. 11 shows the receiver 1500 in more detail. The receiver may include a distribution tank 1502, a drain tank 1504, and a plurality of receiver tubes 1506 that provide fluid communication between the distribution tank 1502 and drain tank 1504. The receiver tubes 1506 are connected to and supported by the distribution tank 1502 and the drain tank 1504. The distribution tank 1502, the drain tank 1504 and the receiver tubes 1506 rotate about the center axis M. In the example of FIG. 11, the distribution tank 1502 and the drain tank 1504 are mounted on a rotating shaft 1508. However, other methods of rotating the distribution tank 1502 and the drain tank 1504 may be used. The receiver 1500 includes a collection sump 1510 that may be fixed, i.e., may not rotate. The drain tank 1504 is mounted on the collection sump 1510 with bearings or rollers 1512 to allow rotation of the drain tank 1504 relative to the collection sump 1510. In other embodiments, the drain tank 1504 may be replaced with a plate (not shown) that provides mounting of the tubes 1506 thereon. Accordingly, the HTF2 may directly drain from the tubes 1506 to the collection sump 1510.

The bottom of the distribution tank 1502 includes a plurality of openings or apertures (not shown). Each opening is connected to a corresponding receiver tube 1506. Similarly, the top of the drain tank 1504 includes a plurality of openings or apertures. Each opening is connected to a corresponding receiver tube 1506. Cold HTF2 is supplied to the distribution tank 1502 from a cold tank or directly from a power block. The cold HTF2 flows from the distribution tank 1502 through each receiver tube 1506, by which the HTF2 is heated. The hot HTF2 then flows into the drain tank 1504 from the receiver tubes 1506. The collection sump 1510 collects the hot HTF2 from the drain tank 1504. The hot HTF2 is then transferred to a hot tank or directly to a power block from the collection sump 1510.

FIG. 12 shows a receiver assembly 1600 according to another embodiment. The receiver 1600 may include multiple single receivers. For example, each receiver of the receiver assembly 1600 may be similar to the receiver 1500 described above. Accordingly, each receiver in FIG. 12 is referred to as receiver 1500. The receiver assembly 1600 rotates about a central axis M to uniformly distribute the regions of heat flux. The receiver assembly 1600 includes a distribution tank 1602, a drain-distribution tank 1604, a drain tank 1605, and a plurality of receiver tubes 1606 that provide fluid communication between the distribution tank 1602, the drain-distribution tank 1604 and the drain tank 1605. The receiver tubes 1606 may be connected to and supported by the distribution tank 1602, the drain-distribution tank 1604 and/or the drain tank 1605. The distribution tank 1602, the drain-distribution tank 1604, the drain tank 1605 and the receiver tubes 1606 rotate about the center axis M. In the example of FIG. 12, the distribution tank 1602, the drain-distribution tank 1604 and the drain tank 1605 are mounted on a rotating shaft 1608. However, other methods of rotating the distribution tank 1602, the drain-distribution tank 1604 and the drain tank 1605 may be used. The receiver assembly 1600 includes a collection sump 1610 that is fixed, i.e., does not rotate. The drain tank 1605 is mounted on the collection sump 1610 with bearings or rollers 1612 to allow rotation of the drain tank 1605 relative to the collection sump 1610. In other embodiments, the drain tank 1605 may be replaced with a plate (not shown) that provides mounting of the tubes 1606 thereon. Accordingly, the HTF2 may directly drain from the tubes 1606 to the collection sump 1610.

The bottom of the distribution tank 1602 includes a plurality of openings or apertures (not shown). Each opening is connected to a corresponding receiver tube 1606 of the upper receiver 1500. The top of the drain-distribution tank 1604 includes a plurality of top openings or apertures. Each top opening is connected to a corresponding receiver tube 1606 of the upper receiver 1500. The bottom of the drain-distribution tank 1604 also includes a plurality of bottom openings or apertures. Each bottom opening is connected to a corresponding receiver tube 1606 of the lower receiver 1500. Cold HTF2 is supplied to the distribution tank 1602 from a cold tank or directly from a power block. The cold HTF2 flows from the distribution tank 1502 though each receiver tube 1606 of the upper receiver 1500, by which the HTF2 is heated. The hot HTF2 then flows through the receiver tubes 1606 of the low receiver 1500 from the drain-distribution tank 1604 so that the HTF2 is further heated. The collection sump 1610 collects the hot HTF2 from the drain tank 1605. The hot HTF2 is then transferred to a hot tank or directly to a power block from the collection sump 1610.

A receiver assembly may include any number of receivers. Each receiver 1500 may be similar such that each receiver may be transported to an assembly site and assembled to form the receiver assembly 1600. The position of each receiver 1500 in the receiver assembly 1600 may be interchangeable. Accordingly, the top receiver 1500 may include the distribution tank 1602 and the bottom receiver 1500 may include the drain tank 1605, while all other receivers 1500 in between the top receiver and the bottom receiver may include drain-distribution tanks 1604. By providing a modular receiver assembly 1600, any size receiver tower may be assembled on-site rather than having a large receiver assembly be constructed off-site and transported to the power plant site. Therefore, depending on the various requirements of a solar power plant, a receiver assembly may be constructed according to the disclosure to include any number of receivers 1500.

The receiver tubes 1506 and 1606 may be similar to receiver tubes that are used in typical receivers of central receiver systems. In one embodiment as shown in FIGS. 11 and 12, each receiver tube 1506 and 1606 is encased in a glass tube 1514 and 1614 to reduce convention cooling of the receiver tube 1506 or 1606, respectively. The space between the glass tube 1514 and 1614 and the receiver tube 1506 and 1606, respectively, may be a vacuum. However, to reduce the cost of manufacturing the receiver tubes 1506 and 1606 and the glass tube 1514 and 1614, the space may be air filled or filled with other gases.

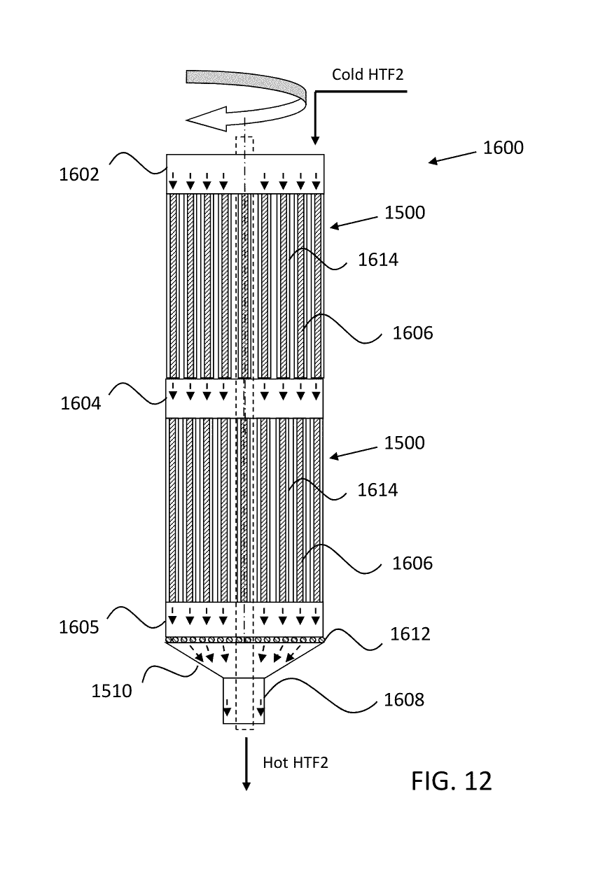

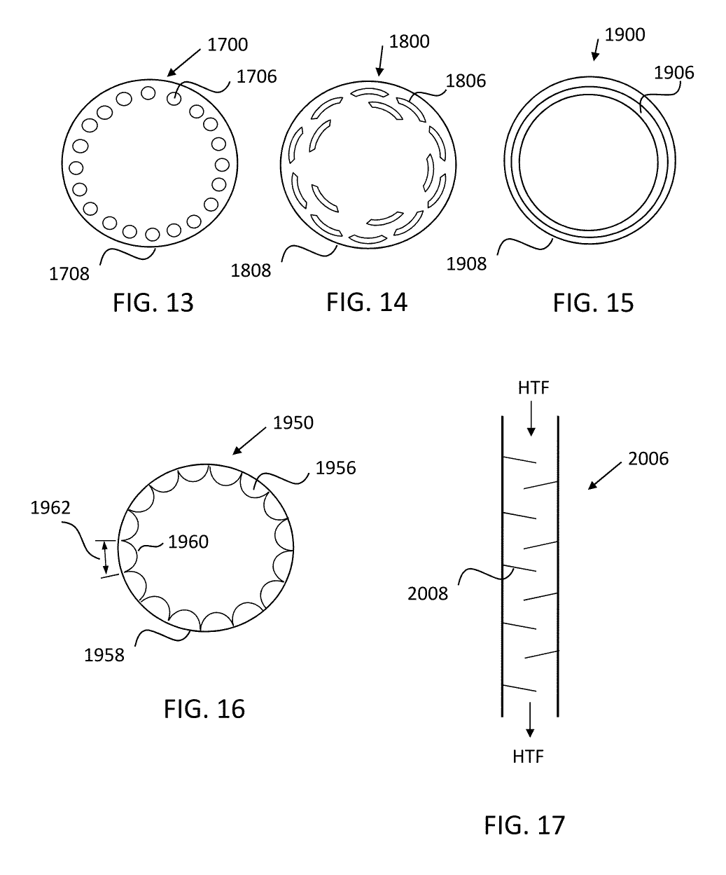

FIG. 13 shows another example of receiver tubes. A receiver 1700 may include a plurality of receiver tubes 1706. To reduce convection cooling of the receiver tubes 1706, all of the receiver tube 1706 may be encased by a glass tube 1708. Thus, instead for each receiver tube being encased in a glass tube, all of the receiver tubes 1706 are encased by a glass tube 1708.

FIG. 14 shows another example of receiver tubes. A receiver 1800 may include a plurality of receiver tubes 1806 that are non-cylindrical to increase the surface area of each receiver tube 1806. In the example of FIG. 14, each receiver tube 1806 defines a section of an annular tube. Accordingly, a larger surface area of each receiver tube 1806 may be exposed to solar radiation. Furthermore, the receiver 1800 may include additional receiver tubes 1806 that are staggered behind the first row of receiver tubes 1806 to absorb any solar radiation that may be reaching the interior of the receiver 1800 from gaps between the first row of receiver tubes 1806. To reduce convection cooling of the receiver tubes 1806, all of the receiver tubes 1806 may be encased by a glass tube 1808.

FIG. 15 shows another example of receiver tubes. A receiver 1900 may include a single annular receiver tube 1906. To reduce convection cooling of the receiver tube 1906, the receiver 1900 may include a glass tube 1908 that encases the receiver tube 1906. Thus, according to the example of FIG. 15, one annular receiver tube 1906 may be used instead of a plurality of receiver tubes.

FIG. 16 shows another example of receiver tubes. A receiver 1950 may include a plurality of receiver tubes 1956, where each receiver tube 1956 is partly defined by the perimeter wall 1958 of the receiver 1950. According to one example shown in FIG. 16, each receiver tube 1956 may be defined by half of a cylinder 1960 and a section 1962 of the perimeter wall 1958. The receiver tubes 1956 may be interconnected along the length of the perimeter wall 1958 or may carry heat transfer fluid independent of each other. To reduce convection cooling of the receiver tubes 1958, the perimeter wall 1958 may be encased by a glass tube (not shown).

FIG. 17 shows a cross-section of a receiver tube 2006 according to one embodiment. As HTF flows through tube 2006, it is heated by the walls of the tube 2006. To maximize conduction of heat from the walls of the tube 2006 to the HTF, the tube 2006 may include a plurality of baffles 2008 that may slow the flow rate of the HTF through the tube 2006. The baffles 2008 may be in any configuration. In the example of FIG. 17, the baffles 2008 are formed by plates that extend from the walls of the tube 2006 toward the center of the tube 2006. Furthermore, the baffles 2008 are staggered so as to extend the length of the path of the HTF flowing through the tube 2006. The baffles 2008 of FIG. 17 represent only one example of an internal structure of the tube 2006 for slowing the flow rate of HTF through the tube 2006. Accordingly, any type of internal structure is possible, such as mesh screens, plates with a plurality of apertures, or funnel shaped structures.

In another embodiment, receiver tubes of a central receiver may not be linear (not shown) in order to increase the path of the HTF flowing through the tubes. For example, the tubes may be curved, have a zigzag shape, or any other shape by which the path of the HTF flowing through the tubes from the top of the receiver to the bottom of the receiver can be increased.

A trough system may be less costly to manufacture, operate and maintain than a central receiver plant. A trough system may provide saturated steam or a combination of superheated steam and saturated steam from hot HTF1 as described above. However, a trough-type plant may be unable to provide mostly superheated steam. Superheated steam may provide about 15% increased efficiency in steam turbine operation as compared to saturated steam. Although a central receiver system can generate superheated steam from HTF2 as described above, central receiver systems are more costly to manufacture, operate and/or maintain. For example, salt is typically used as HTF2 in a central receiver system. Because salt freezes at a relatively high temperature, a central receiver system must maintain the temperature, of the HTF2 well above the freezing point during short or extended non-operative periods. In a trough system, however, synthetic oil is typically used as the HTF1, which freezes at an extremely low temperature that is well below any temperature encountered during the operation of the plant. According to embodiments of the hybrid solar plant, a trough system may be used to generate saturated steam or a combination of saturated steam and superheated steam, while a central receiver system is used to generate superheated steam. Thus, the trough system is used to provide around 75% of the heat for the hybrid plant, while the central receiver system is used to provide the remaining 25% of the heat to generate superheated steam from water. Therefore, as compared to a central receiver system, the hybrid solar plant of the disclosure can have a scaled-down central receiver system while generating the same amount of electricity. Furthermore, as compared to a trough system, the hybrid solar plant of the disclosure can produce superheated steam, which is more efficient for producing electricity than saturated steam. Therefore, overall system efficiency is increased while system complexity and costs are reduced.

Although a particular order of actions is described above, these actions may be performed in other temporal sequences. For example, two or more actions described above may be performed sequentially, concurrently, or simultaneously. Alternatively, two or more actions may be performed in reversed order. Further, one or more actions described above may not be performed at all. The apparatus, methods, and articles of manufacture described herein are not limited in this regard.

While the invention has been described in connection with various aspects, it will be understood that the invention is capable of further modifications. This application is intended to cover any variations, uses or adaptation, of the invention following, in general, the principles of the invention, and including such departures from the present disclosure as come within the known and customary practice within the art to which the invention pertains.

What is claimed is:

1. A solar power plant comprising:
a first solar reflective system configured to heat a first heat transfer fluid to a temperature within a first temperature range;
at least a second solar reflective system coupled to the first solar reflective system, the second solar reflective system having a second heat transfer fluid configured to be heated to a temperature within the first temperature range by the first heat transfer fluid, the second solar reflective system configured to heat the second heat transfer fluid to a temperature within a second temperature range; and
a power generation system coupled to the first solar reflective system and the second solar reflective system and configured to generate electricity by receiving heat from the second first heat transfer fluid and the second heat transfer fluid.

2. The solar power plant of claim 1, wherein the power generation system comprises:
a steam generator configured to generate a first steam with heat from the first heat transfer fluid;
a superheater configured to generate a second steam from the first steam with heat from the second heat transfer fluid; and
wherein the second steam has higher energy than the first steam.

3. The solar power plant of claim 1, wherein the power generation system comprises:
a steam generator configured to generate a first steam with heat from the first heat transfer fluid;
a superheater configured to generate a second steam from the first steam with heat from the second heat transfer fluid;
a steam turbine configured to operate with the second steam; and
wherein the second steam has higher energy than the first steam.

4. The solar power plant of claim 1, wherein the power generation system comprises:
a steam generator configured to generate a first steam from water with heat from the first heat transfer fluid;
a superheater configured to generate a second steam from the first steam with heat from the second heat transfer fluid;
a steam turbine configured to operate with the second steam;
a reheater located downstream of the steam turbine and configured to reheat steam downstream of the steam turbine with the first heat transfer fluid downstream of the superheater; and
wherein the second steam has higher energy than the first steam.

5. The solar power plant of claim 1, wherein the power generation system comprises:
a steam generator configured to generate a first steam with heat from the first heat transfer fluid;
a superheater configured to generate a second steam from the first steam with heat from the second heat transfer fluid;
a first steam turbine configured to operate with the second steam;
a reheater located downstream of the first steam turbine and configured to reheat steam downstream of the first steam turbine with the first heat transfer fluid downstream of the superheater;
a second steam turbine configured to operate with the reheated steam; and
wherein the second steam has higher energy than the first steam.

6. The solar power plant of claim 1, wherein the first solar reflective system comprises:
a plurality of receiver tubes configured to carry the first heat transfer fluid; and
a plurality of reflectors configured to focus sunlight onto the receiver tubes to heat the first heat transfer fluid.

7. The solar power plant of claim 1, wherein the second solar reflective system comprises:
a central receiver comprising at least one tube configured to carry the second heat transfer fluid; and
a plurality of reflectors configured to reflect sunlight onto the central receiver.

8. The solar power plant of claim 1, wherein at least one of the first solar reflective system and the second solar reflective system comprises:
a first storage tank configured to store the first heat transfer fluid in a cold state; and
a second storage tank at least partly surrounded by the first tank and configured to store the first heat transfer fluid in a hot state.

9. The solar power plant of claim 1, wherein the second solar reflective system comprises:
a central receiver comprising at least one tube configured to carry the second heat transfer fluid;
a plurality of reflectors configured to reflect sunlight on the central receiver; and
wherein the central receiver is configured to rotate.

10. A method of generating power from solar energy, the method comprising:
heating a first heat transfer fluid to a temperature within a first temperature range with a first solar reflective system;
heating a second heat transfer fluid to a temperature within the first temperature range with the first heat transfer fluid;
heating the second heat transfer fluid to a temperature within a second temperature range with a second solar reflective system coupled to the first solar reflective system; and
supplying the first heat transfer fluid and the second heat transfer fluid to a power generation system.

11. The method of claim 10, further comprising:
generating a first steam with a steam generator by heating water with heat from the first heat transfer fluid;
generating a second steam with a superheater by heating the first steam with heat from the second heat transfer fluid; and
wherein the second steam has higher energy than the first steam.

12. The method of claim 10, further comprising:
generating a first steam with a steam generator by heating water with heat from the first heat transfer fluid;
generating a second steam with a superheater by heating the first steam with heat from the second heat transfer fluid;
operating a steam turbine with the second steam; and
wherein the second steam has higher energy than the first steam.

13. The method of claim 10, further comprising:
generating a first steam with a steam generator by heating water with heat from the first heat transfer fluid;
generating a second steam with a superheater by heating the first steam with heat from the second heat transfer fluid;
operating a steam turbine with the second steam;
reheating steam with a reheater located downstream of the steam turbine with the first heat transfer fluid downstream of the superheater; and
wherein the second steam has higher energy than the first steam.

14. The method of claim 10, further comprising:
generating a first steam with a steam generator by heating water with heat from the first heat transfer fluid;
generating a second steam with a superheater by heating the first steam with heat from the second heat transfer fluid;
operating a first steam turbine with the second steam;
reheating steam with a reheater located downstream of the first steam turbine with the first heat transfer fluid downstream of the superheater;
operating a second steam turbine with the reheated steam; and
wherein the second steam has higher energy than the first steam.

15. The method of claim 10, wherein heating the first heat transfer fluid to a temperature within the first temperature range with the first solar reflective system comprises heating the first heat transfer fluid inside a plurality of receiver tubes by focusing sunlight onto the receiver tubes with a plurality of reflectors.

16. The method of claim 10, wherein heating the second heat transfer fluid to a temperature within the second temperature range comprises heating the second heat transfer fluid inside at least one receiver tube of a central receiver by a plurality of reflectors reflecting sunlight on the central receiver.

17. The method of claim 10, further comprising storing the first heat transfer fluid in a cold state in a first storage tank, and storing the first heat transfer fluid in a hut state in a second storage tank, and wherein the second storage tank is at least partly surrounded by the first storage tank.

18. The method of claim 10, wherein heating the second heat transfer fluid to a temperature within the second temperature range comprises heating the second heat transfer fluid inside at least one receiver tube of a central receiver by a plurality of reflectors reflecting sunlight on the central receiver, and rotating the central receiver.

19. A method of generating electricity from solar energy, the method comprising:
heating a first heat transfer fluid with a first solar reflective system;
heating a second heat transfer fluid with a second solar reflective system;
generating a first steam from water in a steam generator with the first heat transfer fluid;
generating a second steam in a superheater by heating the first steam with the second heat transfer fluid, the second steam having higher energy than the first steam; and
operating a steam turbine with the second steam.

20. The method of claim 19, further comprising:
reheating the second steam downstream of the steam turbine with the second heat transfer fluid downstream of the superheater; and
operating another steam turbine with the reheated saturated steam.

21. The method of claim 19, further comprising:
reheating the first steam downstream of the steam turbine with the second heat transfer fluid downstream of the superheater;
operating another steam turbine with the reheated saturated steam; and
preheating the water in a preheater with the second heat transfer fluid downstream of the steam generator before generating the first steam.

22. The method of claim 19, further comprising storing the second heat transfer fluid in a cold state in a cold tank and storing the second heat transfer fluid in a hot state in a hot tank located at least partly inside the cold tank.

23. The method of claim 19, further comprising heating the second heat transfer fluid with the first heat transfer fluid before heating the second heat transfer fluid with the second solar reflective system.
